(19) United States
(12) Patent Application Publication
(10) Pub. No.: US 2012/0264023 A1
(43) Pub. Date: Oct. 18, 2012

(54) BIO-FUEL CELL FUEL SUPPLY BODY AND BIO-FUEL CELL SYSTEM

(75) Inventors: Hideki Sakai, Kanagawa (JP); Hiroki Mita, Kanagawa (JP); Shuji Fujita, Tokyo (JP); Ryuhei Matsumoto, Kanagawa (JP); Tsunetoshi Samukawa, Kanagawa (JP)

(73) Assignee: SONY CORPORATION, Tokyo (JP)

(21) Appl. No.: 13/436,311

(22) Filed: Mar. 30, 2012

(30) Foreign Application Priority Data
Apr. 12, 2011 (JP) 2011-088248

(51) Int. Cl. H01M 8/16

(52) U.S. Cl. 429/401

(57) ABSTRACT

A fuel supply body is partially or wholly formed from a material having a biopolymer as a main component and a biocatalyst that metabolically decomposes the biopolymer is contained therein or immobilized thereto. A bio-fuel cell system is constituted of the fuel supply body and a bio-fuel cell including electrodes with an oxidation-reduction enzyme present on a surface thereof to supply fuel and/or the biocatalyst from the fuel supply body to the bio-fuel cell and also to use the fuel supply body itself as the fuel.

### CROSS REFERENCES TO RELATED APPLICATIONS

The present application claims priority to Japanese Priority Patent Application JP 2011-088248 filed in the Japan Patent Office on Apr. 12, 2011, the entire content of which is hereby incorporated by reference.

### BACKGROUND

The present disclosure relates to a fuel supply body to supply fuel to a bio-fuel cell and a bio-fuel cell system. In particular, the present disclosure relates to a bio-fuel cell system using an oxidation-reduction enzyme and a fuel supply body thereof.

A bio-fuel cell using an oxidation-reduction enzyme as a reaction catalyst can efficiently extract electrons from fuel like glucose or ethanol that is not used by an ordinary industrial catalyst and thus attracts attention as a next-generation fuel cell with high capacity and safety. FIG. 10 is a diagram schematically showing the principle of power generation of a bio-fuel cell using an enzyme. If, for example, a bio-fuel cell uses glucose as fuel as shown in FIG. 10, an anode 101 decomposes glucose by an enzyme immobilized on the surface thereof to extract electrons (e⁻) and also produce protons (H⁺).

A cathode 102 generates water (H₂O) from protons (H⁺) transported from the anode 101 via a proton conductor 103, electrons (e⁻) sent by passing through an external circuit, and oxygen (O₂), for example, in the air. Then, with these reactions of the anode and the cathode occurring simultaneously, electric energy is produced between the anode and the cathode.

On the other hand, a fuel cell can generate power continuously over a long period by supplying additional fuel and thus, various types of fuel supply cartridges have been proposed (see, for example, Japanese Patent Application No. 2002-270210, Japanese Patent Application No. 2003-123821, and Japanese Patent Application No. 2005-011613). For example, a fuel cell cartridge described in Japanese Patent Application No. 2002-270210 and Japanese Patent Application No. 2003-123821 is configured to internally decompose hydrocarbon containing oxygen by a biochemical catalyst such as microbes and to supply generated hydrogen to the fuel cell. A fuel cartridge described in Japanese Patent Application No. 2005-011613 seeks to promote safety during disposal by adopting a configuration capable of extracting internally remaining fuel.

### SUMMARY

However, for fuel cartridges for fuel cells using hydrogen or methanol as described in Japanese Patent Application No. 2002-270210, Japanese Patent Application No. 2003-123821 and Japanese Patent Application No. 2005-011613, it is necessary to airtightly enclose a fuel reservoir portion with a robust housing and supply fuel to a power generation unit only when necessary to secure safety while in use. Thus, such existing fuel cartridges for fuel cells have a problem of extremely low usability.

In addition, existing cartridges have a large proportion of portions that make no contribution to power generation for robust housing and the like, causing a problem of low energy capacity density of cartridges. Further, existing cartridges take much time and effort to discard or recover used cartridges, resulting in a problem of low usability.

It is desirable that the present disclosure provide a bio-fuel cell fuel supply body with high usability and a large energy capacity and a bio-fuel cell system.

A bio-fuel cell fuel supply body according to the present disclosure is partially or wholly formed from a material having a biopolymer as a main component and a biocatalyst that metabolically decomposes the biopolymer is contained therein or immobilized thereto.

In the present disclosure, the bio-fuel cell fuel supply body is partially or wholly formed from a biopolymer and a biocatalyst that decomposes the biopolymer is contained therein or immobilized thereto and therefore, the biopolymer can be decomposed by the biocatalyst when necessary.

The fuel supply body includes, for example, a fuel containing portion in which fuel is contained and a biocatalyst containing portion in which the biocatalyst is contained, wherein the fuel containing portion and the biocatalyst containing portion can be formed from the material having the biopolymer as the main component.

In that case, the fuel containing portion and the biocatalyst containing portion may be provided independently.

If the fuel is in a solid state, the fuel containing portion can also serve as the biocatalyst containing portion.

On the other hand, the biocatalyst may be contained or immobilized in an inactive state.

The biopolymer is, for example, carbohydrate.

Further, if the biopolymer is cellulose, cellulase can be used as the biocatalyst.

If the biopolymer is starch, amylase can be used as the biocatalyst.

If the fuel containing portion and the biocatalyst containing portion are formed from the material having the biopolymer that is different from the biopolymer of the fuel as the main component, a first biocatalyst that metabolically decomposes the biopolymer as the main component of the material and a second biocatalyst that metabolically decomposes the biopolymer contained in the fuel may be contained in the biocatalyst containing portion.

A bio-fuel cell system according to the present disclosure includes the above fuel supply body and a bio-fuel cell including electrodes with an oxidation-reduction enzyme present on a surface thereof, wherein fuel and/or a biocatalyst is supplied from the fuel supply body to the bio-fuel cell and the fuel supply body itself is also used as the fuel.

In the system, the bio-fuel cell can be provided with a fuel reservoir portion including a mechanism that cuts, ruptures, or crushes the fuel supply body and in that case, the fuel supply body is decomposed in the fuel reservoir portion.

On the other hand, another bio-fuel cell system according to the present disclosure includes a fuel supply body partially or wholly formed from a material having a biopolymer as a main component and a bio-fuel cell including at least a power generation unit including electrodes with an oxidation-reduction enzyme present on a surface thereof and a fuel reforming unit that reforms primary fuel into secondary fuel capable of emitting electrons, wherein a biocatalyst that decomposes the biopolymer constituting the fuel supply body is contained in or immobilized to the fuel reforming unit of the bio-fuel cell.

According to the present disclosure, a fuel supply body can be metabolically decomposed by a biocatalyst and thus, usability is improved and also the energy capacity can be increased.

Additional features and advantages are described herein, and will be apparent from the following Detailed Description and the figures.

### BRIEF DESCRIPTION OF THE FIGURES

FIG. 1 is a diagram schematically showing the configuration of a fuel supply body according to a first embodiment of the present disclosure;

FIG. 2 is a diagram schematically showing a state in which particles of fuel 5 and particles of a biocatalyst 6 are mixed and contained in the fuel supply body according to a second embodiment of the present disclosure;

FIG. 3 is a diagram schematically showing the state in which the biocatalyst 6 is sandwiched between the fuels 5 in the fuel supply body according to the second embodiment of the present disclosure;

FIG. 4 is a diagram schematically showing the state in which the biocatalyst 6 is included in the fuel 5 in the fuel supply body according to the second embodiment of the present disclosure;

FIG. 5 is a schematic diagram showing a method of separating components other than biopolymers by using an adsorbent in a bio-fuel cell system according to a third embodiment of the present disclosure;

FIG. 6 is a schematic diagram showing a method of separating components other than biopolymers by an electric field in the bio-fuel cell system according to the third embodiment of the present disclosure;

FIG. 7 is a schematic diagram showing a method of separating components other than biopolymers by a magnetic field in the bio-fuel cell system according to the third embodiment of the present disclosure;

FIG. 8 is a schematic diagram showing a method of separating components other than biopolymers by a low-polar organic solvent in the bio-fuel cell system according to the third embodiment of the present disclosure;

FIG. 9 is a conceptual diagram showing the configuration of a fuel reformer of a bio-fuel cell used in the bio-fuel cell system according to a fourth embodiment of the present disclosure; and

FIG. 10 is a diagram schematically showing the principle of power generation of the bio-fuel cell using an enzyme.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Embodiments to carry out the present disclosure will be described in detail below with reference to appended drawings. However, the present disclosure is not limited to each embodiment shown below. The description will be provided in the order shown below:
1. First Embodiment

(Example of a fuel supply body provided with a fuel containing portion and a biocatalyst containing portion)
2. Second Embodiment

(Example of the fuel supply body in which the biocatalyst containing portion is not provided independently)
3. Third Embodiment

(Example of a bio-fuel cell system using the fuel supply body including a biocatalyst)
4. Fourth Embodiment

(Example of the bio-fuel cell system in which the biocatalyst is contained in or immobilized to the cell)

### 1. First Embodiment

### [Overall Configuration of A Fuel Supply Body]

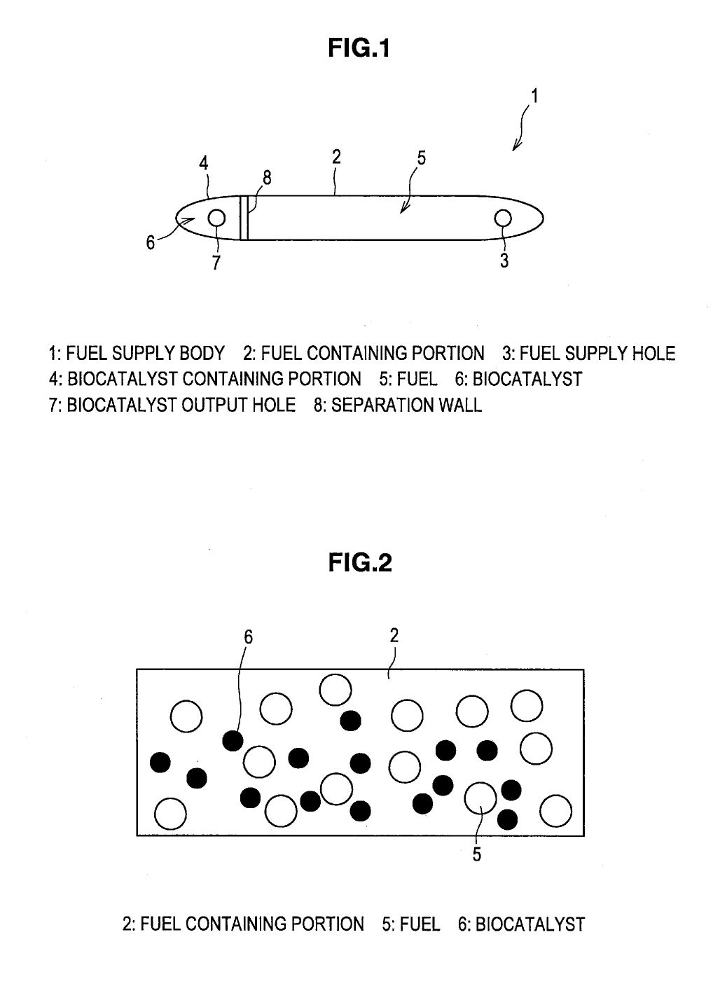

First, a bio-fuel cell fuel supply body according to the first embodiment of the present disclosure will be described. FIG. 1 is a diagram schematically showing the configuration of a fuel supply body according to the first embodiment of the present disclosure. As shown in FIG. 1, a fuel supply body 1 in the present embodiment is provided with a fuel containing portion 2 in which the fuel 5 is contained, a fuel supply hole 3 to supply the fuel 5 to a fuel cell, and a biocatalyst containing portion 4 in which the biocatalyst 6 is contained.

### [Fuel Containing Portion 2]

The fuel containing portion 2 is formed from a material containing a biopolymer as a main component and the fuel 5 is contained therewithin. The fuel 5 here refers to fuel components such as sugar, alcohol, aldehyde, lipid, and proteins or a solution containing at least one of these fuel components. More specifically, sugars such as glucose, fructose, and sorbose, alcohols such as methanol, ethanol, propanol, glycerin, and polyvinyl alcohol, aldehydes such as formaldehyde and acetaldehyde, and organic acid such as acetic acid, formic acid, and pyruvic acid.

In addition, fats, proteins, and organic acids as intermediate products of glucose metabolism may also be used as fuel components. The form of the fuel 5 is not specifically limited and various forms such as liquid, powder, and solid fuels can be used.

On the other hand, biopolymers constituting the fuel containing portion 2 include, for example, sugars (carbohydrates) such as glucose, fructose, maltose, and cellulose, proteins (enzymes and peptide) such as casein, collagen, keratin, and fibroin, nucleic acids such as DNA and RNA, and biodegradable polymers such as polylactic acid. Among these biopolymers, it is preferable to use carbohydrates and particularly, starch and cellulose are suitable.

The biopolymer constituting the fuel containing portion 2 may be the same as the biopolymer contained in the fuel 5 or a biopolymer that is different from the biopolymer contained in the fuel 5 may be used. Further, a plurality of types of biopolymers may be mixed and used.

If the fuel containing portion 2 is formed from a hygroscopic material such as cellulose, the liquid fuel 5 may leak from the fuel containing portion 2 or the solid or powder fuel 5 may be degraded by moisture penetrating under moistening conditions outside. Thus, the fuel containing portion 2 desirably has water barrier properties. The method of giving water barrier properties to the fuel containing portion 2 is not specifically limited and if the fuel containing portion 2 is formed from, for example, cellulose, holes through which moisture is penetrated may be reduced by increasing the mass density and further, hydrophobic coating may be applied to the surface (or the inner surface and outer surface) of the fuel containing portion 2.

By coating the surface with a hydrophobic protein film, the whole fuel containing portion 2 can be formed from biodegradable materials. By increasing water barrier properties of the fuel containing portion 2 in this manner, degradation of the fuel 5 due to infestation of worms and fungi can be prevented.

### [Fuel Supply Hole 3]

The fuel supply hole 3 is intended for input/output of the fuel 5 and is used when the fuel 5 contained in the fuel containing portion 2 is supplied to a bio-fuel cell, the fuel containing portion 2 is refilled with the fuel 5, or a waste liquid in the bio-fuel cell is recovered. The fuel supply hole 3 can optionally be opened/closed by a switching mechanism (not shown).

The configuration of the switching mechanism is not specifically limited and, for example, a configuration in which a cut line is provided in a portion of the fuel containing portion 2 and the fuel supply hole 3 is opened by pressing the portion or a configuration in which the fuel supply hole 3 is sealed with paper or a plastic material can be considered. The fuel supply hole 3 is normally closed in the fuel supply body 1 according to the present embodiment and is opened only when the fuel 5 is input or output. Accordingly, penetration of moisture or infestation of worms and fungi is prevented so that degradation of the fuel 5 can be prevented.

Further, the fuel supply hole 3 may be structured to be linkable to a fuel inlet provided in the bio-fuel cell. The number and position of the fuel inlet/outlet holes 3 are not specifically limited and can appropriately be set in accordance with the configuration of the bio-fuel cell.

### [Biocatalyst Containing Portion 4]

The biocatalyst containing portion 4 is intended to contain a biocatalyst that metabolically decomposes biopolymers and is formed from, like the fuel containing portion 2 described above, a material having a biopolymer such as sugars (carbohydrates), proteins, nucleic acids, and biodegradable polymers as a main component. Carbohydrate is preferably used as the biopolymer constituting the biocatalyst containing portion 4 and particularly, starch and cellulose are suitable.

The biocatalyst containing portion 4 may be formed from the same material as the material of the fuel containing portion 2, but may be formed from a material containing a different biopolymer. The biocatalyst containing portion 4 may also use the same biopolymer as the biopolymer contained in the fuel 5 or a biopolymer that is different from the biopolymer contained in the fuel 5. Further, a plurality of types of biopolymers may be mixed and used. Further, the biocatalyst containing portion 4 also desirably has water barrier properties, thereby preventing degradation of the biocatalyst 6 due to infestation of worms and fungi.

On the other hand, the biocatalyst 6 contained in the biocatalyst containing portion 4 is only to be able to decompose at least the fuel containing portion 2 and the biocatalyst containing portion 4 and, for example, enzymes such as cellulase, amylase, glucosidase, and protease or microbes can be used. Particularly, if the biopolymer constituting the fuel containing portion 2 and the biocatalyst containing portion 4 is cellulose, cellulase is suitable and if the biopolymer is starch, amylase is suitable.

In addition to the biopolymers constituting the fuel containing portion 2 and the biocatalyst containing portion 4, a biocatalyst that metabolically decomposes the biopolymer contained in the fuel 5 may be contained in the biocatalyst containing portion 4. Accordingly, cell performance is improved because a biocatalytic reaction of the negative electrode of the bio-fuel cell becomes quick or is restored.

Further, a biocatalyst output hole 7 may be provided in the biocatalyst containing portion 4 so that a biocatalyst that metabolically decomposes biopolymers contained in the biocatalyst 6 or the fuel 5 can be introduced into the bio-fuel cell or fuel reformer via the biocatalyst output hole 7. Accordingly, cell performance and fuel reforming performance can be improved or restored. In such a case, like the fuel supply hole 3 described above, the biocatalyst output hole 7 can also desirably be opened/closed optionally by a switching mechanism (not shown) such as a seal to prevent degradation of the biocatalyst 6.

The biocatalyst 6 may be contained in an active state, but is desirably contained in an inactive state by a method of drying or the like. Accordingly, the biocatalyst 6 can be made to exist stably for a long period of time. If, on the other hand, the biocatalyst 6 is contained in an active state, it is necessary to form a layer that is not decomposed by the biocatalyst 6 on a surface that comes into contact with the biocatalyst 6 of the biocatalyst containing portion 4 so that no metabolic reaction occurs.

Further, the biocatalyst containing portion 4 desirably has a heat-resistant structure and/or a heat insulated structure. Accordingly, degradation of the biocatalyst by heat from outside can be prevented. While the fuel supply body 1 shown in FIG. 1 has a configuration in which the biocatalyst 6 and the fuel 5 do not come into contact due to a separation wall 8, the present disclosure is not limited to such a configuration and, for example, the biocatalyst containing portion 4 may be provided inside the fuel containing portion 2, for example, in the center portion thereof.

### [Outside Surface of the Fuel Supply Body 1]

The fuel supply body 1 according to the present embodiment desirably has antibacterial coating or vermin repellent coating that keeps worms and fungi at bay applied to the outside surface thereof. Moreover, a light blocking effect may be gained by providing a light reflection layer or heat resistance may be given by providing a heat insulating layer. Further, if printing is done on the surface and ink derived from soybeans is used, the printed portion can also be decomposed by the biocatalyst 6.

### [Method For Use]

Next, the method of using the fuel supply body 1 described above will be described. When the fuel supply body 1 shown in FIG. 1 is used, the fuel containing portion 2 is filled with the fuel 5 and also the biocatalyst 6 is included in the biocatalyst containing portion. Then, the fuel 5 is supplied to the bio-fuel cell via the fuel supply hole 3 if necessary and after the fuel 5 in the fuel containing portion 2 all is supplied, the fuel containing portion 2 is metabolically decomposed by the biocatalyst 6 in the biocatalyst containing portion 4.

The biocatalyst 6 can be supplied to the bio-fuel cell or the fuel reformer thereof together with the fuel 5 or alone. Further, the fuel supply body 1 according to the present embodiment can be used after being refilled with the fuel 5 and the biocatalyst 6.

On the other hand, the method of decomposing the fuel supply body 1 is not specifically limited and, for example, biopolymers constituting the biocatalyst containing portion 4 and the fuel containing portion 2 are brought into contact with the biocatalyst 6 by destroying or removing the separation wall 8 between the biocatalyst containing portion 4 and the fuel containing portion 2 or crushing the whole fuel supply body 1 by a shredder or the like. Accordingly, decomposition of biopolymers constituting the biocatalyst containing portion 4 and the fuel containing portion 2 is started by the biocatalyst 6. Even if the biocatalyst 6 is contained in a solid state or in an inactive state such as a dry state, the biocatalyst 6 is activated after being brought into contact with the fuel 5 in a liquid state or an electrolytic solution.

In the fuel supply body 1 according to the present embodiment, the fuel containing portion 2 and the biocatalyst containing portion 4 are formed from materials containing a biopolymer as main component and the biocatalyst 6 that metabolically decomposes the biopolymer is contained in the biocatalyst containing portion 4 and thus, the fuel containing portion 2 and the biocatalyst containing portion 4 can be decomposed by the biocatalyst 6 after using the fuel supply body 1. Accordingly, no recycling costs of the fuel supply body 1 incur and usability is also improved.

Further, the fuel 5 with which the fuel supply body 1 according to the present embodiment is filled is safer than fuel used in existing fuel cells and thus, it is not necessary to airtightly enclose the fuel 5 with a robust housing. Thus, compared with existing fuel cartridges, the structure thereof can be simplified, the reduction in weight and lower costs can be realized, and further, the energy capacity of the whole cartridge can be increased.

In the fuel supply body 1 according to the present embodiment, not only the fuel containing portion 2 and the biocatalyst containing portion 4, but also other portions may be formed from materials containing a biopolymer as a main component. In such a case, the fuel supply body 1 after being used can be used as fuel by providing a crushing mechanism such as a shredder in a fuel input portion of the bio-fuel cell using cellulose or starch as fuel. Accordingly, a cartridge of 100% renewal energy can be realized.

### 2. Second Embodiment

### [Overall Configuration of the Fuel Supply Body]

Next, the fuel supply body according to a second embodiment of the present disclosure will be described. In the fuel supply body 1 shown in FIG. 1, the biocatalyst containing portion 4 and the fuel containing portion 2 are provided independently and the biocatalyst 6 and the fuel 5 are configured not to be in contact, but the present disclosure is not limited to such an example and contains a configuration in which the biocatalyst containing portion is not provided independently.

### [Containing State of the Fuel 5 And the Biocatalyst 6]

FIGS. 2 to 4 are diagrams schematically showing containing states of the fuel 5 and the biocatalyst 6 in the fuel supply body according to the second embodiment of the present disclosure. If, as shown, for example, in FIG. 2, the fuel 5 is in a solid state, a configuration in which the fuel containing portion 2 serves also as the biocatalyst containing portion 4, that is, a configuration in which both particles of the fuel 5 and particles of the biocatalyst 6 are contained and mixed in a portion serving both as the fuel containing portion 2 and the biocatalyst containing portion 4 can be adopted.

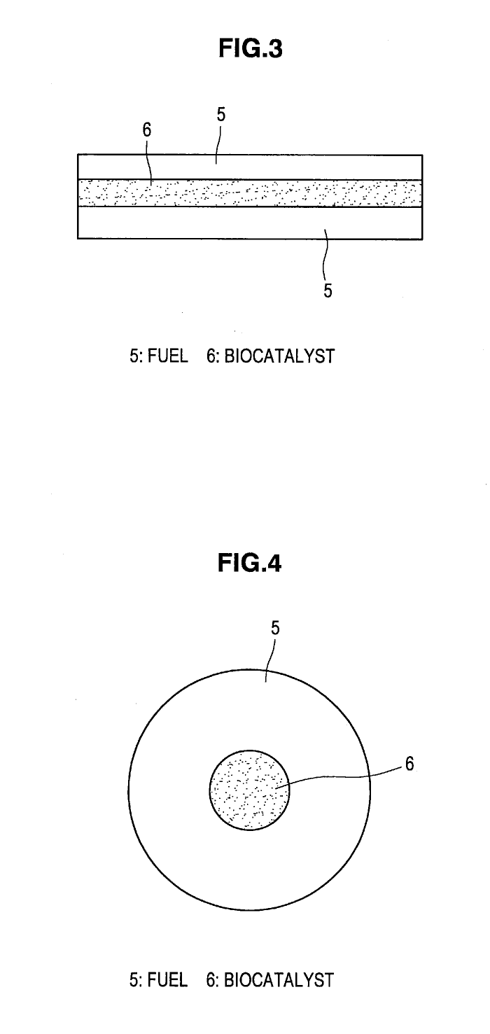

Also, a configuration in which the biocatalyst 6 is fixed to the fuel supply body 1 or the fuel 5 may be adopted. More specifically, one side or both sides of the sheet-shaped fuel 5 may be coated with the biocatalyst 6. Alternatively, as shown in FIG. 3, the biocatalyst 6 may be contained by being sandwiched between the fuels 5 or, as shown in FIG. 4, by being included in the fuel 5 in a substantially spherical shape.

Further, a portion of the surface or the whole surface of the fuel supply body 1 may be formed from a portion of the surface or the whole surface of the fuel supply body 1 with a material containing the biocatalyst 6. In such a case, it is desirable to form particularly a portion in contact with the fuel 5 from a material immobilizing the biocatalyst 6 or the containing the biocatalyst 6. However, if each of the above containing states is adopted, the fuel 5 and the biocatalyst 6 come into contact and thus, it is desirable to use the biocatalyst 6 that does not decompose the fuel 5 or to inactivate the biocatalyst 6 when necessary.

If, as described above, the fuel 5 and the biocatalyst 6 are mixed or the biocatalyst 6 is fixed to the fuel 5 or the fuel supply body 1, the area of contact of the fuel 5 and the biocatalyst 6 increases and thus, the rate of reaction for decomposition can be increased. The other configuration and effect of the fuel supply body in the present embodiment than those described above are the same as those in the first embodiment described above.

### 3. Third Embodiment

### [Overall Configuration of A Bio-Fuel Cell System]

Next, a bio-fuel cell system according to a third embodiment of the present disclosure will be described. In the bio-fuel cell system according to the present embodiment, fuel and a biocatalyst that metabolically decomposes a biopolymer contained in the fuel are supplied to a bio-fuel cell by using the first or second fuel supply body described above.

More specifically, a bio-fuel cell of the present system includes at least a power generation unit including electrodes with an oxidation-reduction enzyme present on the surface thereof and a fuel reservoir portion that stores fuel to be introduced into the power generation unit. Then, the fuel with which the fuel supply body is filled is supplied to the fuel reservoir portion.

### [Fuel Reservoir Portion]

On the other hand, the fuel reservoir portion of the bio-fuel cell is provided with a mechanism to cut, rupture, or crush the fuel supply body (hereinafter, referred to generically as a crushing mechanism). Then, by crushing the fuel supply body by the crushing mechanism, a biopolymer constituting the fuel containing portion 2 and the biocatalyst containing portion 4 can be decomposed by a biocatalyst. As a result, the fuel supply body itself can be used as fuel in the bio-fuel cell system according to the present embodiment.

### [Separation/Recovery Mechanism of Unnecessary Components]

If a fuel supply body should be used as fuel, the presence of components other than biopolymers causes a problem. FIGS. 5 to 8 are diagrams schematically showing the method of separating/recovering components other than biopolymers. As described above, biopolymer components of crushed bodies la of the fuel supply body input into the fuel reservoir portion and crushed by the crushing mechanism are gradually decomposed by the biocatalyst.

With the decomposition, components other than biopolymers such as ink, plastics, and metal are released in a solution (biocatalyst/biopolymer containing solution 6a) containing the biocatalyst. Then, decomposition of the biopolymers may be inhibited by components other than the biopolymers. Thus, when a fuel supply body is used as fuel of a bio-fuel cell, it is necessary to separate and recover components other than biopolymers.

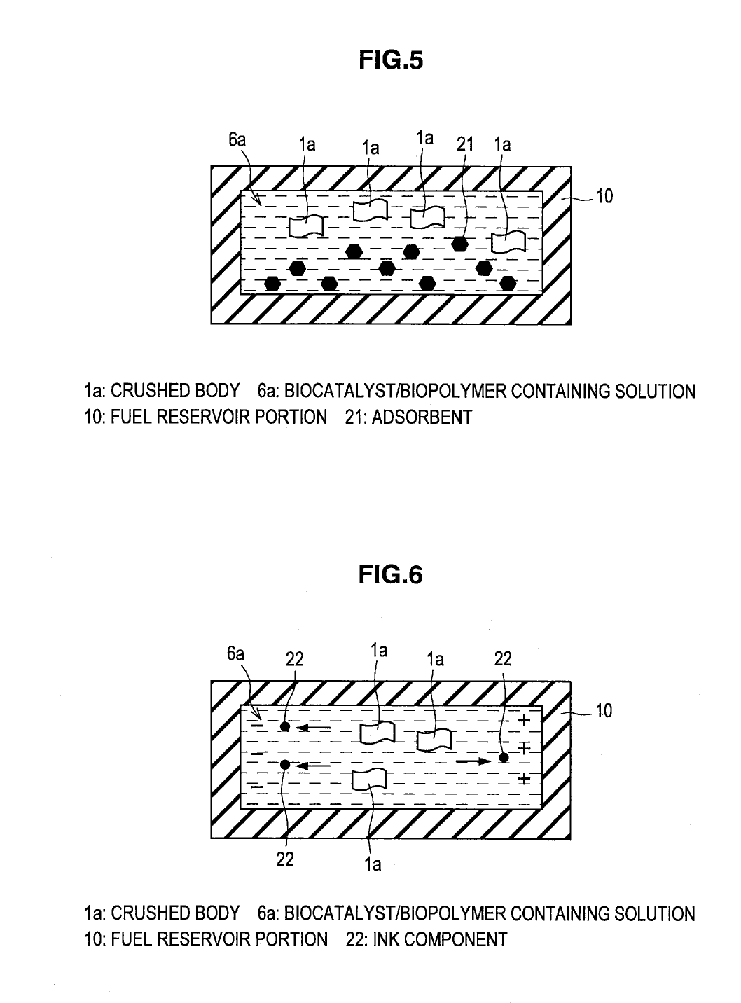

More specifically, as shown in FIG. 5, a method of separating and recovering components other than biopolymers using a adsorbent 21 such as activated carbon and zeolite in the fuel reservoir portion or, as shown in FIG. 6, a method of separating and recovering ink components 22 due to an electrophoretic effect by applying an electric field can be considered. For the method shown in FIG. 6, a portion of electric power generated by the bio-fuel cell can be used.

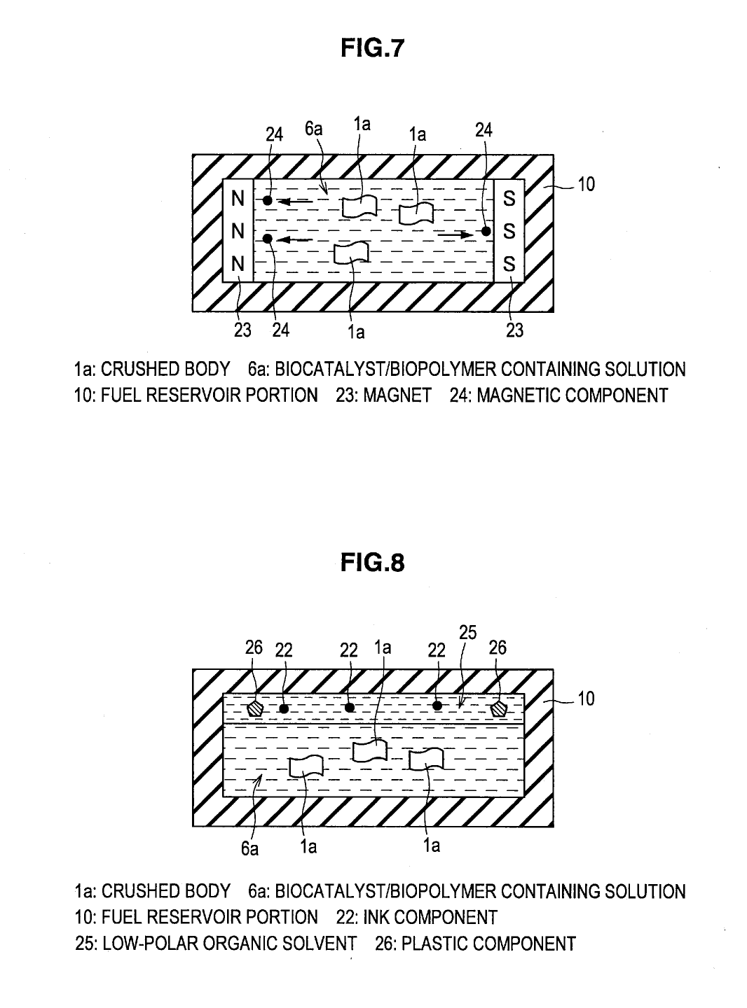

Also as shown in FIG. 7, a method of separating and recovering magnetic components 24 by installing a magnet 23 is available. Further, as shown in FIG. 8, the ink components 22 and plastic components 26 can be separated if a low-polar layer is formed by a low-polar organic solvent 25 or the like.

In a bio-fuel cell system according to the present embodiment, the first or second fuel supply body described above is used and also the fuel reservoir portion of the bio-fuel cell is provided with the crushing mechanism that crushes the fuel supply body, for example, and thus, the fuel supply body itself can be used as fuel. As a result, no recycling costs of the fuel supply body incur, usability is improved, and the energy capacity can be increased.

Further, performance degradation of the biocatalyst can be prevented by separating/recovering components other than biopolymers. Then, by reusing each separated/recovered component, the reduction of material costs, reduction of environmental loads, and resource savings can be expected.

### 4. Fourth Embodiment

### [Overall Configuration of the Bio-Fuel Cell System]

Next, the bio-fuel cell system according to a fourth embodiment of the present disclosure will be described. In the third embodiment described above, a bio-fuel cell system using a bio-fuel body including a biocatalyst is described, but the present disclosure is not limited to such an example and can also use a bio-fuel cell including a biocatalyst.

More specifically, the bio-fuel cell in the present system includes at least a power generation unit including electrodes with an oxidation-reduction enzyme present on the surface thereof and a fuel reforming unit and a biocatalyst is contained in or immobilized to the fuel reforming unit. Then, the fuel reformed by the fuel reforming unit is introduced into the power generation unit. In this case, it is not necessary for the fuel supply body to include the biocatalyst and the fuel supply body is only to be partially or wholly formed from a material having a biopolymer that can be decomposed by the biocatalyst contained in or immobilized to the fuel reforming unit and/or another biopolymer as a main component.

### [Fuel Reforming Unit]

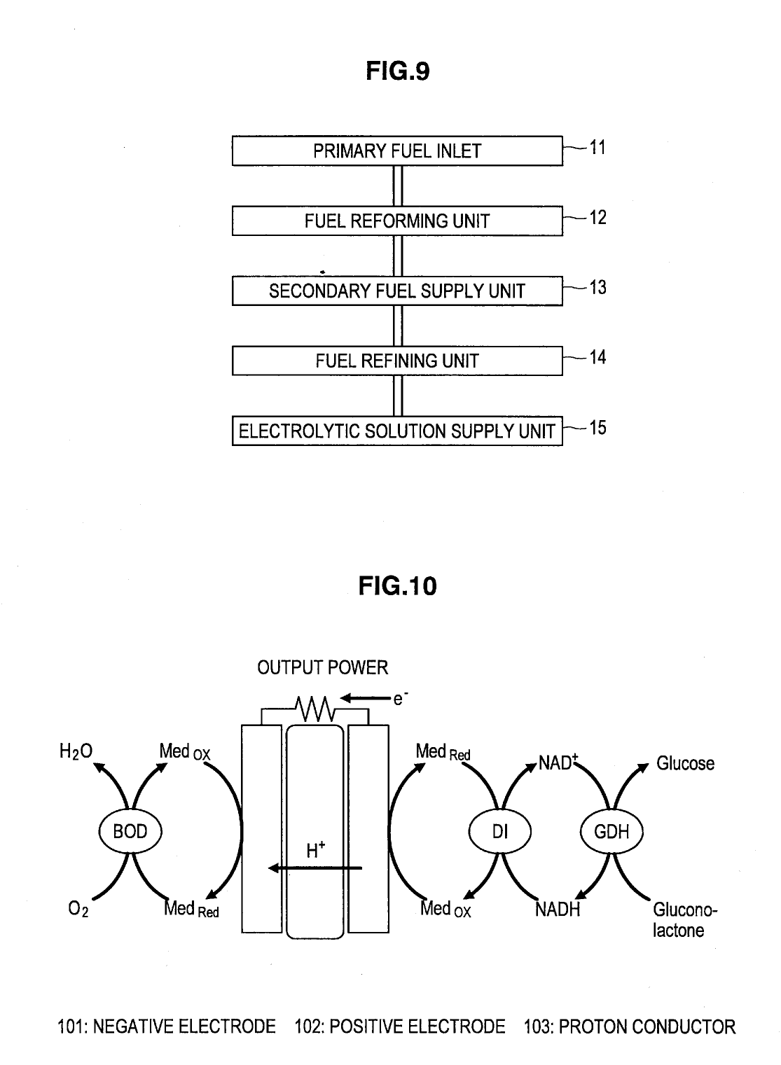

FIG. 9 is a conceptual diagram showing the configuration of a fuel reformer of a bio-fuel cell used in the bio-fuel cell system according to the fourth embodiment of the present disclosure. As shown in FIG. 9, the fuel reformer in the present embodiment includes at least a primary fuel inlet 11 to introduce primary fuel, a fuel reforming unit 12 that reforms the primary fuel into secondary fuel, and a secondary fuel supply unit 13 to supply the secondary fuel to a fuel cell. A fuel refining unit 14 and an electrolytic solution supply unit 15 may also be included when necessary.

If, for example, the biopolymer constituting the fuel supply body is cellulose or starch, the primary fuel such as cellulose or starch is reformed into secondary fuel capable of emitting electrons by an oxidation-reduction reaction caused by the biocatalyst in the fuel reforming unit 12 or the fuel refining unit 14 of the fuel reformer.

In a bio-fuel cell system according to the present embodiment, as described above, a fuel reforming unit including a biocatalyst is provided in a bio-fuel cell and thus, if a fuel supply body is formed from a biopolymer, the fuel supply body can be used as fuel even without including the biocatalyst. Further, by using a fuel supply body including a biocatalyst as that in the first or second embodiment described above, decomposition performance can be improved or restored. The other configuration and effect of the bio-fuel cell system in the present embodiment than those described above are the same as those in the third embodiment described above.

It should be understood by those skilled in the art that various modifications, combinations, sub-combinations and alterations may occur depending on design requirements and other factors insofar as they are within the scope of the appended claims or the equivalents thereof.

Additionally, the present disclosure may also be configured as below.
(1) A bio-fuel cell fuel supply body,
wherein the bio-fuel cell fuel supply body is partially or wholly formed from a material having a biopolymer as a main component, and a biocatalyst that metabolically decomposes the biopolymer is contained therein or immobilized thereto.
(2) The bio-fuel cell fuel supply body according to (1), further including:
a fuel containing portion in which fuel is contained; and
a biocatalyst containing portion in which the biocatalyst is contained,
wherein the fuel containing portion and the biocatalyst containing portion are formed from the material having the biopolymer as the main component.
(3) The bio-fuel cell fuel supply body according to (2),
wherein the fuel containing portion and the biocatalyst containing portion are provided independently.
(4) The bio-fuel cell fuel supply body according to (3),
   wherein the fuel is in a solid state and the fuel containing portion also serves as the biocatalyst containing portion.
(5) The bio-fuel cell fuel supply body according to any one of (1) to (4),
wherein the biocatalyst is contained or immobilized in an inactive state.
(6) The bio-fuel cell fuel supply body according to any one of (1) to (5),
wherein the biopolymer is carbohydrate.
(7) The bio-fuel cell fuel supply body according to any one of (1) to (5),
wherein the biopolymer is cellulose and the biocatalyst is cellulase.
(8) The bio-fuel cell fuel supply body according to any one of (1) to (5),
wherein the biopolymer is starch and the biocatalyst is amylase.
(9) The bio-fuel cell fuel supply body according to any one of (2) to (5),
wherein the fuel containing portion and the biocatalyst containing portion are formed from the material having the biopolymer that is different from the biopolymer of the fuel as the main component, and
a first biocatalyst that metabolically decomposes the biopolymer as the main component of the material and a second biocatalyst that metabolically decomposes the biopolymer contained in the fuel are contained in the biocatalyst containing portion.
(10) A bio-fuel cell system including:
the fuel supply body according to any one of (1) to (9); and
a bio-fuel cell including electrodes with an oxidation-reduction enzyme present on a surface thereof,
wherein fuel and/or a biocatalyst is supplied from the fuel supply body to the bio-fuel cell and the fuel supply body itself is also used as the fuel.
(11) The bio-fuel cell system according to (10),
wherein the bio-fuel cell is provided with a fuel reservoir portion including a mechanism that cuts, ruptures, or crushes the fuel supply body and the fuel supply body is decomposed in the fuel reservoir portion.
(12) A bio-fuel cell system including:
a fuel supply body partially or wholly formed from a material having a biopolymer as a main component; and
a bio-fuel cell including at least a power generation unit including electrodes with an oxidation-reduction enzyme present on a surface thereof and a fuel reforming unit that reforms primary fuel into secondary fuel capable of emitting electrons,
wherein a biocatalyst that decomposes the biopolymer constituting the fuel supply body is contained in or immobilized to the fuel reforming unit of the bio-fuel cell.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A bio-fuel cell fuel supply body,
wherein the bio-fuel cell fuel supply body is partially or wholly formed from a material having a biopolymer as a main component, and
a biocatalyst that metabolically decomposes the biopolymer is contained therein or immobilized thereto.

2. The bio-fuel cell fuel supply body according to claim 1, further comprising:
a fuel containing portion in which fuel is contained; and
a biocatalyst containing portion in which the biocatalyst is contained,
wherein the fuel containing portion and the biocatalyst containing portion are formed from the material having the biopolymer as the main component.

3. The bio-fuel cell fuel supply body according to claim 2,
wherein the fuel containing portion and the biocatalyst containing portion are provided independently.

4. The bio-fuel cell fuel supply body according to claim 2,
wherein the fuel is in a solid state and the fuel containing portion also serves as the biocatalyst containing portion.

5. The bio-fuel cell fuel supply body according to claim 1,
wherein the biocatalyst is contained or immobilized in an inactive state.

6. The bio-fuel cell fuel supply body according to claim 1,
wherein the biopolymer is carbohydrate.

7. The bio-fuel cell fuel supply body according to claim 1,
wherein the biopolymer is cellulose and the biocatalyst is cellulase.

8. The bio-fuel cell fuel supply body according to claim 1,
wherein the biopolymer is starch and the biocatalyst is amylase.

9. The bio-fuel cell fuel supply body according to claim 2,
wherein the fuel containing portion and the biocatalyst containing portion are formed from the material having the biopolymer that is different from the biopolymer of the fuel as the main component, and
a first biocatalyst that metabolically decomposes the biopolymer as the main component of the material and a second biocatalyst that metabolically decomposes the biopolymer contained in the fuel are contained in the biocatalyst containing portion.

10. A bio-fuel cell system comprising:
the fuel supply body according to claim 1; and
a bio-fuel cell including electrodes with an oxidation-reduction enzyme present on a surface thereof,
wherein fuel and/or a biocatalyst is supplied from the fuel supply body to the bio-fuel cell and the fuel supply body itself is also used as the fuel.

11. The bio-fuel cell system according to claim 10,
wherein the bio-fuel cell is provided with a fuel reservoir portion including a mechanism that cuts, ruptures, or crushes the fuel supply body and the fuel supply body is decomposed in the fuel reservoir portion.

12. A bio-fuel cell system comprising:
a fuel supply body partially or wholly formed from a material having a biopolymer as a main component; and
a bio-fuel cell including at least a power generation unit including electrodes with an oxidation-reduction enzyme present on a surface thereof and a fuel reforming unit that reforms primary fuel into secondary fuel capable of emitting electrons,
wherein a biocatalyst that decomposes the biopolymer constituting the fuel supply body is contained in or immobilized to the fuel reforming unit of the bio-fuel cell.
